(19) United States
(12) Patent Application Publication
(10) Pub. No.: US 2010/0115683 A1
(43) Pub. Date: May 13, 2010

(54) SIGNAGE SYSTEM

(75) Inventors: Martijn Krans, Eindhoven (NL); Anthonie Hendrik Bergman, Eindhoven (NL); Bartel Marinus Van De Sluis, Eindhoven (NL); Erich Zainzinger, Hong Kong (CN); Wouter Bastiaan Zeper, Eindhoven (NL); Guido Theo Maria Lamerichs, Leuven (BE); Thomas Schuler, Leuven (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 12/525,897

(22) PCT Filed: Feb. 5, 2008
(86) PCT No.: PCT/IB2008/050409

§ 371 Date: Aug. 5, 2009

(30) Foreign Application Priority Data
Feb. 12, 2007 (EP) 07102138.0

(51) Int. Cl. A41B 1/00; G09G 5/00; G09G 3/32; H04Q 5/22; H04R 3/00; G10L 15/00

(52) U.S. Cl. 2/115; 345/207; 345/82; 340/10.1; 381/122; 704/270; 704/E15.001

(57) ABSTRACT

The present invention relates to a signage system (10) comprising: a plurality of textile products (12) each comprising a flexible display device (16). For controlling the displays (16), the system further comprises a central unit (14, 24) adapted to emit at least one control signal, each of which being a sound signal or a light signal. To this end, each textile product further comprises means (20, 26) for detecting the control signal(s) emitted by the central unit (14, 24), and means (18) linked to the detection means (20, 26) and display (16) for controlling the display (16) in accordance with the detected control signal(s). The present invention also relates to a method, central units and uses of such for controlling a plurality of flexible display devices each comprised in a textile product.

### FIELD OF THE INVENTION

The present invention relates to a signage system comprising a plurality of textile products each comprising a flexible display device. The present invention also relates to a method, central units and uses of such for controlling a plurality of flexible display devices each comprised in a textile product.

### BACKGROUND OF THE INVENTION

An example of a textile product comprising a flexible display device is disclosed in WO2006/014230. More precisely, WO2006/014230 describes a flexible display screen with a plurality of light emitting diodes acting as pixels in a matrix pattern. The display is installed in a jacket. The display may for instance be held by a pocket or pouch in proximity to the outer cloth of the jacket, which pocket or pouch resides inside the lining of the jacket. The display is controlled by a control circuit connected to it, and the system is powered by a battery pack. Both the control circuit and battery pack may also be placed within the jacket. Upon operation, light from the display is transmitted through the outer cloth so that an illuminated message, for instance a word, may be shown “on” the jacket. Such a jacket can be used at events for promotion or marketing purposes, as personal protective clothing of highway and railroad workers, or police, fire and ambulance crews, etc.

It may be desirable to use a plurality of such displays nearby each other to show a larger message. To this end, WO2006/014230 discloses an example set in a sports arena where individual members of the crowd represent smaller area screens and the crowd collectively makes up a large area screen. Here, each individual may dial up a telephone number by means of a wireless phone and input the seating or standing area they are located in. An Internet linked computer server communicating with each individual phone can then compute the appropriate data to send to each wireless phone. Each phone can then relay the data through a wired interface to the individuals' small screen or through a wireless radio interface such as Bluetooth.

However, an issue when using multiple displays, especially for presenting a dynamic composite message, is that the operation of the individual displays may have to be synchronized; otherwise the composite message may not be presented correctly.

### SUMMARY OF THE INVENTION

It is an object of the present invention to address this issue, and to provide an improved signage system, the displays of which easily can be synchronized.

According to a first aspect, there is provided a signage system comprising: a plurality of textile products each comprising a flexible display device; and a central unit for controlling the displays, wherein the central unit is adapted to emit at least one control signal, each control signal being a sound signal or a light signal, and wherein each textile product further comprises means for detecting the control signal(s) emitted by the central unit, and means linked to the detection means and display for controlling the display in accordance with the detected control signal(s).

The invention is based on the understanding that a central unit can be used as a remote control to synchronize the operation of the plural displays, for instance by transmitting a single “on” signal to all displays allowing identical or related animations to be started on all displays at the same time.

In one embodiment, the at least one control signal comprises a predetermined control signal, and the control means in at least one of the textile products is adapted to execute a certain display function upon detection of the predetermined control signal. For instance, the displays may be turned on/off. This ensures that the displays are not triggered or otherwise controlled by just any light or sound signal, but by a specific, predetermined control signal. The predetermined control signal may for example have a specific frequency, sequence of frequencies, and/or modulation. Further, different control signals can be used to trigger different displays. For instance a first control signal may be used to turn a first group of displays on (or off), while a second control signal is used to turn a second group of displays on (or off). Other display functions that can be associated with control signals include but are not limited to switching or initiating display content, controlling brightness, contrast, frame rate, rotation, flipping, etc.

In one embodiment, each control signal is a light signal and the detection means is a photo detector, whereby detection of the light by the photo detector may trigger the displays. Preferably, the light signal is an infrared signal (IR) and the photo detector is an IR detector. Transmission via infrared technology is well known per se, and relatively easy and cheap to implement. In a further embodiment, the control means is further adapted to select a display content to be showed on the display in accordance with the frequency and/or modulation of the detected light signal. For instance, an IR signal from the central unit having a first modulation can initiate the display of a first image or animation or play list (with images/animations, for example), and an IR signal having a second, different modulation can initiate the display of a second, different image or animation or play list. Thus, by emitting IR signals with different modulation (and/or frequency), the central unit can control the contents of the displays. Further, when using an infrared signal, the central unit is preferably a wide beam infrared remote control, so that the displays of several textile products can be initiated all at once. Instead of an infrared signal, a flash light or any visible or non-visible light of a dedicated frequency could be used to trigger the displays.

In another embodiment, each control signal is a sound signal and the detection means is a microphone, whereby detection of the sound by the microphone may trigger the displays. The use of sound signals is beneficial since it in general does not require line of sight. In a further embodiment, the control means is further adapted to select a display content to be showed on the display in accordance with the frequency or sequence of frequencies of the sound signal detected by the microphone. For instance, a sound signal having a first frequency can initiate the display of a first image or animation or play list, and a sound having a second, different frequency can initiate the display of a second, different image or animation or play list. Thus, by emitting sound signals with different frequencies, the central unit can control the contents of the displays. To determine the frequency of the sound signal, each textile product may comprise a frequency analyzer, for example. In yet a further embodiment, the control means is further adapted to select a display content to be showed on the display device in accordance with a spoken word or phrase of the sound signal detected by the microphone. For instance, a first word can initiate the display of a first image or animation, and a second, different word can initiate the display of a second, different image or animation. Thus, by pronouncing different words or phrases, the central unit can control the contents of the displays. Alternatively, the different control words or phrases could be uttered by a person. To determine the word or phrase, each textile product should have voice recognition capability. Hereto, techniques for voice recognition are known per se.

In an envisaged embodiment, the textile product is a garment, such as a shirt, and the flexible display device is preferably a light emitting diode (LED) based display.

According to another aspect of the invention, there is provided a method for controlling a plurality of flexible display devices each comprised in a textile product, comprising the step of emitting at least one control signal, each control signal being a sound signal or light signal, wherein each textile product further comprises means for detecting the emitted control signal(s), and means linked to the detection means and display for controlling the display in accordance with the detected control signal(s).

In yet other aspects, the invention relates to a wide beam infrared remote control and its use for controlling a plurality of flexible display devices each comprised in a textile product, wherein each textile product further comprises an infrared detector for detecting an infrared signal emitted by the wide beam infrared remote control, and means linked to the infrared detector and display for controlling the display in accordance with the detected infrared signal.

In still other aspects, the invention relates to a central sound emitting unit and its use for controlling a plurality of flexible display devices each comprised in a textile product, wherein each textile product further comprises a microphone for detecting a sound signal emitted by the central unit, and means linked to the microphone and display for controlling the display in accordance with the detected sound signal.

These aspects exhibit similar advantages as the first discussed aspect of the invention.

### BRIEF DESCRIPTION OF THE DRAWINGS

These and other aspects of the present invention will now be described in more detail, with reference to the appended drawings showing a currently preferred embodiment of the invention.

FIG. 1 schematically illustrates a signage system according to an embodiment of the invention using infrared signals.

FIG. 2 schematically illustrates a signage system according to another embodiment of the invention using sound signals.

### DETAILED DESCRIPTION

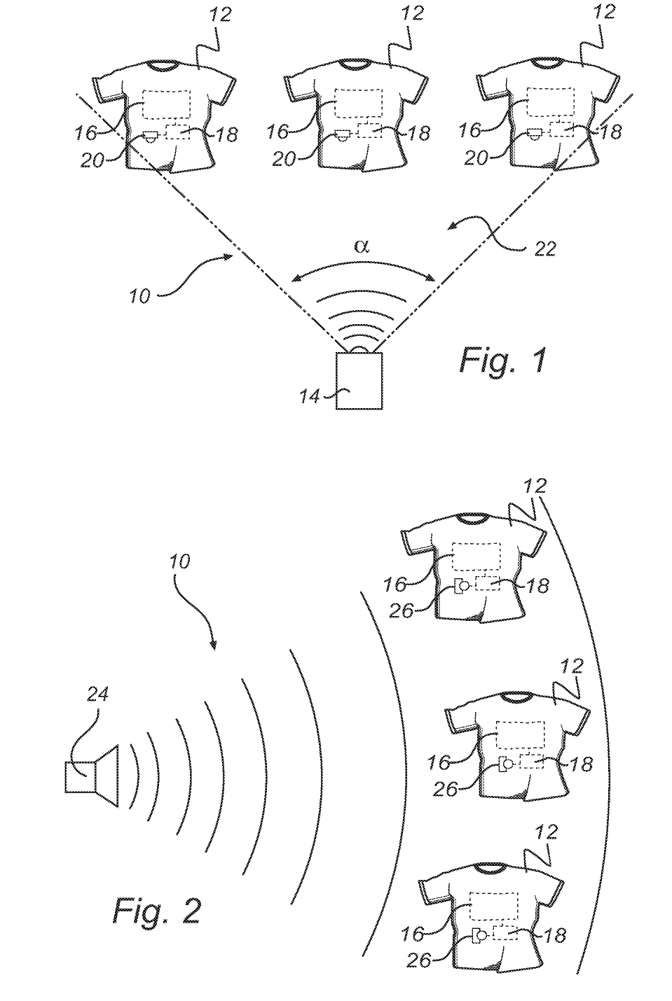

FIG. 1 schematically illustrates a signage system 10 according to an embodiment of the invention. The system 10 comprises plurality of textile products 12, which in FIG. 1 are garments, more precisely shirts. Alternatively, the textile products 12 may be other garments, such as jackets or vests, or a piece of furniture, a bag, etc. Each shirt 12 comprises a flexible display device 16 (in the following “display” 16). The display 16 is installed behind the outer cloth of the shirt 12. Preferably, the display 16 comprises a plurality of light emitting diodes (LEDs) mounted on a flexible substrate (not shown). Such an LED display can be made relatively thin and flexible, and is power efficient, which is especially beneficial when used in a shirt. When the display 16 is on, an illuminated image or animation or other message may be shown through the outer cloth on the shirt 12. On the other hand, when the display 16 is off, the display 16 is hardly visible from outside the shirt 12.

Each shirt 12 further comprises a control unit 18 linked to the display 16. The control unit 18 is generally adapted to control the display 16, such as initiating the showing of display content on the display 16. The display content may be an image, animation, letter, number, word or other message. The display 16 and control unit 18 (as well as any additional electronic components) are preferably powered by a battery pack (not shown) also incorporated in the shirt 12.

According to an embodiment of the invention, the signage system 10 further comprises an infrared (IR) remote control 14 for controlling the displays 16. The infrared remote control 14 is adapted to emit various IR (i.e. electromagnetic radiation of wavelengths between approximately 750 nm and 1 mm) control signals to one or more or all of the textile products/displays within range. To receive the IR signals, each shirt 12 further comprises an IR detector 20. The IR detector 20 is linked to the control unit 18 and adapted to detect the IR control signal emitted by the IR remote control 14. Preferably, the IR remote control 14 is a wide beam IR remote control adapted to emit an IR signal covering a relatively broad sector 22, so that the signal can be picked up by several IR detectors 20 within the sector 22 at the same time. The angle of divergence α of a particular IR signal emitted by the IR remote control 14 may for example be in the order of about 40° up to about 180°. The latter can be obtained for instance by placing several IR light sources next to each other, each with a slightly tilted angle. Thus, only one signal has to be emitted from the IR remote control 14 in order to reach several shirts 12. The control unit 18 in each shirt 12 is further adapted to actuate or otherwise control the display 16 upon detection of the IR signal from the IR remote control 14. Thus, as the IR signal is detected by the IR detector 20, a preprogrammed animation or image may be shown on each display 16. Consequently, all displays 16 of the plural shirts 12 may be actuated or started at essentially the same time based on a single IR signal emitted by the IR remote control 14, allowing synchronized operation of the displays in order to provide a unified message. The unified message may for example be formed by having each of the displays showing a different letter of a three letter word. Alternatively, a unified, dynamic message may be an animation running synchronized at the same time on all displays, or an animation moving from one display to the next and so on, etc.

The above IR signal used to actuate the displays preferably has a predetermined frequency and/or modulation, to distinguish it from any other IR signals that might be present. To this end, the control unit 18 may be adapted to trigger the displays (for instance show a preprogrammed animation) only upon detection of the IR signal having the predetermined frequency and/or modulation. Further, by emitting IR signals of different frequencies/modulations, different animations (or other display contents) could be initiated on the displays, or different display functions could be executed, such as change of brightness, contrast, frame rate, rotation, flipping, etc. To this end, the IR remote control 14 could be embodied like a regular TV remote (portable, battery powered, with buttons), wherein instead of switching TV channels, changing contrast, etc., the IR remote control 14 is used to change the contents shown of the displays, turning displays on/off, change the contrast/brightness of the displays, etc.

FIG. 2 schematically illustrates a signage system 10 according to another embodiment of the invention. The system 10 comprises plurality of textile products 12, which in FIG. 2 are garments, more precisely shirts. Alternatively, the textile products 12 may be other garments, such as jackets or vests, or a piece of furniture, a bag, etc. Each shirt 12 comprises a flexible display device 16 (in the following “display” 16). The display 16 is installed behind the outer cloth of the shirt 12. Preferably, the display 16 comprises a plurality of light emitting diodes (LEDs) mounted on a flexible substrate (not shown). Such an LED display can be made relatively thin and flexible, and is power efficient, which is especially beneficial when used in a shirt. When the display 16 is on, an illuminated image or animation or other message may be shown through the outer cloth on the shirt 12. On the other hand, when the display 16 is off, the display 16 is hardly visible from outside the shirt 12.

Each shirt 12 further comprises a control unit 18 linked to the display 16. The control unit 18 is generally adapted to control the display 16, such as initiating the showing of display content on the display 16. The display content may be an image, animation, letter, number, word or other message. The display 16 and control unit 18 (as well as any additional electronic components) are preferably powered by a battery pack (not shown) also incorporated in the shirt 12.

According to an embodiment of the invention, the signage system 10 further comprises a central remote control unit 24 for controlling the displays 16. The central remote control unit 24 is adapted to emit various sound control signals to one or more or all of the textile products/displays within range. To receive the sound signals, each shirt 12 further comprises a microphone 26. The microphone 26 is linked to the control unit 18 and adapted to detect the control signal emitted by the central unit 24. The central unit 24 may be any sound emitting device (e.g. loudspeaker, piezo speaker, whistle, etc.) adapted to emit a sound signal. The control unit 18 in each shirt 12 is further adapted to actuate or otherwise control the display 16 upon detection of the sound signal from the central unit 24. Thus, as the sound signal is detected by the microphone 26, a preprogrammed animation or image may be shown on each display 16. Consequently, all displays 16 of the plural shirts 12 may be actuated or started at essentially the same time based on a single sound signal emitted by the central unit 24, allowing synchronized operation of the displays 16 in order to provide a unified message. The above sound signal used to actuate the displays preferably has a predetermined frequency or sequence of frequencies, to distinguish it from any other sounds that might be present. To this end, the control unit 18 may be adapted to trigger the display (for instance show a preprogrammed animation) only upon detection of the sound signal having the predetermined frequency. Further, the unified message may for example be formed by having each of the displays 12 showing a different letter of a three letter word. Alternatively, a dynamic, unified message may be an animation running synchronized at the same time on all displays, or an animation moving from one display to the next and so on, etc.

In a further embodiment, each control unit 18 may further be adapted to select a display content to be showed on the display 16, or to execute different display functions (change of brightness, contrast, frame rate, rotation, flipping, etc), in accordance with the frequency or sequence of frequencies of the sound signal detected by the microphone 26. For instance, a sound signal having a first frequency can initiate the display of a first preprogrammed image or animation, and a sound having a second, different frequency can initiate the display of a second, different preprogrammed image or animation. Thus, by emitting sound signals with different frequencies, the central unit 24 can control the contents of the displays 16. To determine the frequency of the sound signal, each shirt may comprise a frequency analyzer, for example.

In yet a further embodiment, each control unit 18 may further be adapted to select a display content to be showed on the display 16 in accordance with a spoken word or phrase of the sound signal detected by the microphone 24. For instance, a first word can initiate the display of a preprogrammed first image or animation, and a second, different word can initiate the display of a second, different preprogrammed image or animation. Thus, by pronouncing different words or phrases, the central unit 24 can control the contents of the displays 16. Alternatively, the different control words or phrases could be uttered by a person, in which case the loudspeaker 24 can be omitted. To determine the word or phrase, each textile product should have voice recognition capability (not shown). Hereto, techniques for voice recognition are known per se.

The person skilled in the art realizes that the present invention by no means is limited to the preferred embodiments described above. On the contrary, many modifications and variations are possible within the scope of the appended claims. For instance, with reference to FIG. 1, instead of an infrared signal, a flash light or any light signal of a dedicated frequency together with appropriate photo detectors in the shirts could be used to trigger or otherwise control the displays.

1. A signage system (10) comprising: a plurality of textile products (12) each comprising a flexible display device (16); and a central unit (14, 24) for controlling said displays (16), wherein said central unit is adapted to emit at least one control signal, each control signal being a sound signal or a light signal, and wherein each textile product (12) further comprises means (20, 26) for detecting the control signal(s) emitted by said central unit (14, 24), and means (18) linked to the detection means (20, 26) and display (16) for controlling said display (16) in accordance with said detected control signal(s).

2. A system according to claim 1, wherein said at least one control signal comprises a predetermined control signal, and wherein the control means in at least one of the textile products is adapted to execute a certain display function upon detection of said predetermined control signal.

3. A system according to claim 1, wherein each control signal is a light signal and said detection means is a photo detector.

4. A system according to claim 3, wherein said light signal is an infrared signal and said photo detector is an infrared detector (20).

5. A system according to claim 3, wherein the control means is further adapted to select a display content to be showed on the display device in accordance with the frequency and/or modulation of the detected light signal.

6. A system according to claim 4, wherein said central unit is a wide beam infrared remote control (14).

7. A system according to claim 1, wherein each control signal is a sound signal and said detection means is a microphone (26).

8. A system according to claim 7, wherein the control means is further adapted to select a display content to be showed on the display device in accordance with the frequency or sequence of frequencies of the detected sound signal.

9. A system according to claim 7, wherein the control means is further adapted to select a display content to be showed on the display device in accordance with a spoken word or phrase of the detected sound signal.

10. A system according to claim 1, wherein said textile product is a garment, such as a shirt.

11. A system according to claim 1, wherein the flexible display device is an LED based display.

12. A method for controlling a plurality of flexible display devices (16) each comprised in a textile product (12), comprising the step of emitting at least one control signal, each control signal being a sound signal or light signal, wherein each textile product (12) further comprises means (20, 26) for detecting the emitted control signal(s), and means (18) linked to the detection means (20, 26) and display (16) for controlling said display (16) in accordance with said detected control signal(s).

13. A wide beam infrared remote control (14) for controlling a plurality of flexible display devices (16) each comprised in a textile product (12), wherein each textile product (12) further comprises an infrared detector (20) for detecting an infrared signal emitted by the wide beam infrared remote control (14), and means (18) linked to the infrared detector (20) and display (16) for controlling said display (16) in accordance with said detected infrared signal.

14-16. (canceled)
